(19) United States
(12) Patent Application Publication
(10) Pub. No.: US 2024/0219803 A1
(43) Pub. Date: Jul. 4, 2024

(54) ELECTRO-OPTICAL MODULATOR

(71) Applicants: SMART PHOTONICS HOLDING B.V., Eindhoven (NL); NEDERLANDSE ORGANISATIE VOOR WETENSCHAPPELIJK ONDERZOEK (NWO), Den Haag (NL); TECHNISCHE UNIVERSITEIT EINDHOVEN, Eindhoven (NL)

(72) Inventor: Arezou MEIGHAN, Eindhoven (NL)

(21) Appl. No.: 18/604,344

(22) Filed: Mar. 13, 2024

Related U.S. Application Data
(63) Continuation of application No. PCT/EP2021/075258, filed on Sep. 14, 2021.

(51) Int. Cl. G02F 1/225; G02F 1/01

(52) U.S. Cl. CPC G02F 1/2257; G02F 1/0121

(57) ABSTRACT

An electro-optical modulator for a photonic integrated circuit, comprising: a substrate; a first waveguide on a first portion of the substrate; a second waveguide on a second portion of the substrate; a first electrode in contact with the first waveguide, the first waveguide between the first electrode and the first portion of the substrate; and a second electrode in contact with the second waveguide, the second waveguide between the second electrode and the second portion of the substrate.

### CROSS-REFERENCE TO RELATED APPLICATIONS

This application is a continuation under 35 U.S.C. § 120 of International Application No. PCT/EP2021/075258, filed Sep. 14, 2021. The above-referenced patent application is incorporated by reference in its entirety.

### BACKGROUND

Electro-optical modulators are used to modulate the intensity of an optical signal by modulating an electrical signal. This allows the conversion of electrical signals into optical signals, for example for optical communications systems and optical systems. Faster modulation of optical signals can allow more accurate optical data transmission and higher rates of optical data transmission.

Semiconductor structures can be used in photonic integrated circuits (PICs) to perform various functions. It is desirable to provide an improved electro-optical modulator for a PIC.

### BRIEF DESCRIPTION OF THE DRAWINGS

FIG. 1 shows schematically a cross-section view of parts of an example electro-optical modulator in accordance with examples.

FIG. 2 shows schematically a plan view of the parts of the electro-optical modulator of FIG. 1.

FIG. 3 shows schematically a side-view of the parts of the electro-optical modulator of FIG. 1.

FIGS. 4 to 7 shows schematically cross-section views of parts of the different electro-optical modulators in accordance with different examples.

FIG. 8 shows schematically application of potential differences in accordance with examples.

FIG. 9 shows schematically a plan view of a photonic integrated circuit in accordance with examples.

FIG. 10 shows schematically a plan view of photonic integrated circuit in accordance with further examples.

FIG. 11 shows schematically a plan view of a system for electro-optical modulation in accordance with examples.

FIG. 12 illustrates a method of modulating an optical signal in accordance with examples.

FIG. 13 illustrates a method of manufacturing an electro-optical modulator in accordance with examples.

### DETAILED DESCRIPTION

Examples described herein relate to an electro-optical modulator for use in a PIC. More specifically, examples described herein comprise a semiconductor structure for modulation of an optical signal in response to an electrical signal. Modulating a difference in effective optical path length between a first waveguide and a second waveguide of the modulator, and combining and interfering the output from each waveguide, allows the modulation of the intensity of the output due to constructive and destructive interference. Modulating the difference in effective optical path length between the first waveguide and the second waveguide is achieved by modulating a difference between a potential difference applied across the first waveguide and a potential difference applied across the second waveguide, due to the electro-optical effect. In some examples the electro-optical modulator is a Mach-Zehnder modulator. Mach-Zehnder modulators give fast modulation speed and large optical extinction.

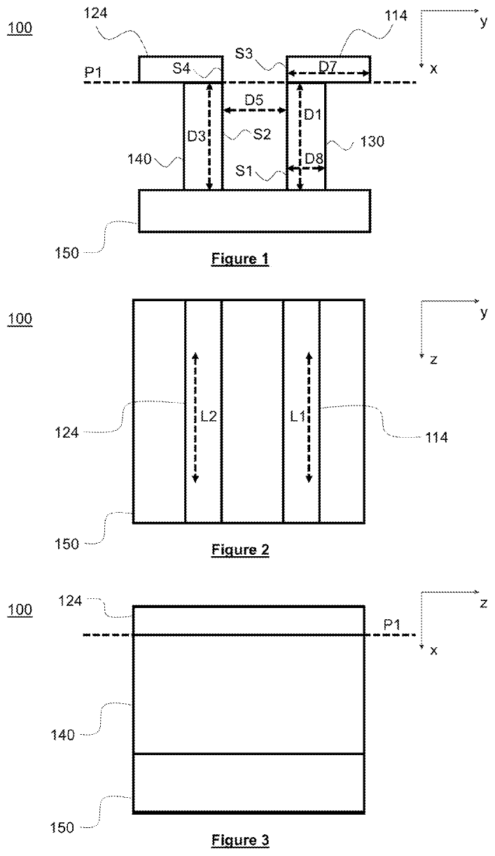

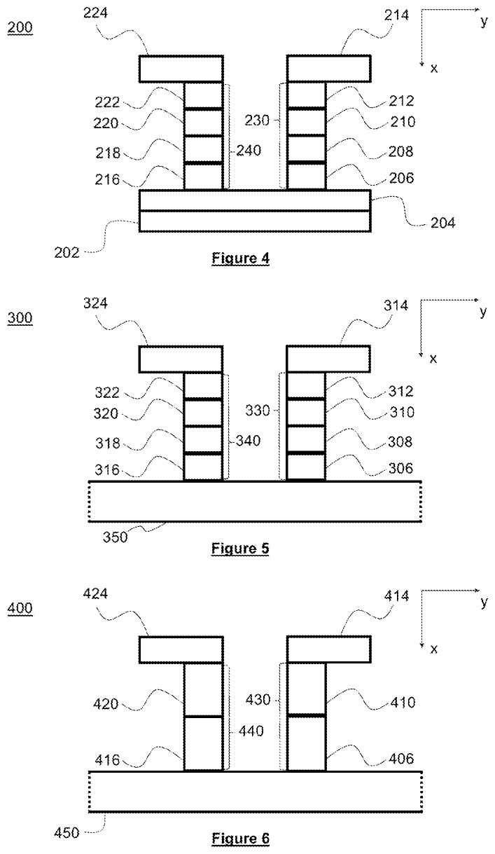

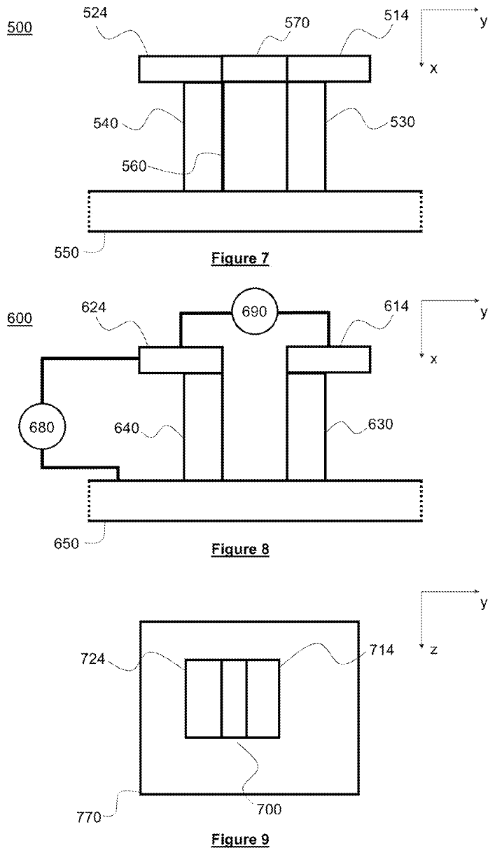

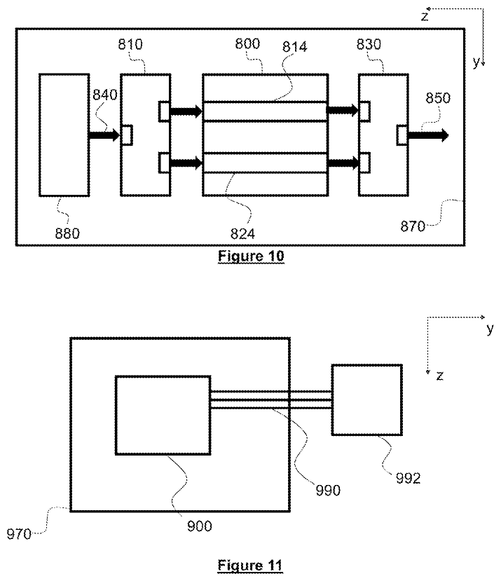

In examples, an electro-optical modulator (100) for a PIC comprises: a substrate (150); a first waveguide (130) on a first portion of the substrate; a second waveguide (140) on a second portion of the substrate; a first electrode (114) on, and in contact with, the first waveguide; and a second electrode (124) on, and in contact with, the second waveguide. Some such examples are illustrated by FIGS. 1 to 3, and corresponding reference numerals are given earlier in this paragraph.

With the first waveguide between the first electrode and the first portion of the substrate, the first electrode can be considered for example to be part of a first stack of layers on the first portion of the substrate. This stack occupies a relatively small area, or footprint, on the substrate, which can contribute to a more compact modulator. Similar reasoning applies to the second electrode as part of what can be considered a second stack on the second portion of the substrate, further contributing to a more compact modulator. Further, with the electrodes on the waveguides as described, the two electrodes can be positioned closer to each other than in known examples, which can help for designing a modulator e.g. with a lower capacitance than known alternatives.

A person skilled in the art will appreciate that a waveguide is for guiding light. Light propagates within a waveguide and is confined within a waveguide due to reflection at the boundaries of the waveguide. A waveguide usually has a refractive index higher than the refractive index of material in contact with the waveguide at the boundaries at which confinement of light is desired. For example, due to this refractive index difference at the boundaries at which confinement of light is desired, total internal reflection takes place when the angle of incidence at these boundaries of the waveguide is greater than the critical angle. In this manner, a waveguide guides the propagation of the light. For a particular optical mode to propagate in the waveguide, it is desired that the light reflected at the boundaries of the waveguide fulfils the conditions for constructive interference.

In examples, such as those of FIGS. 1 to 3, a first distance (D1) between the first electrode and the first portion of the substrate is substantially the same (e.g. within acceptable manufacturing and/or performance tolerances) as a second distance (D3) between the second electrode and the second portion of the substrate, The first distance and the second distance are each perpendicular a light propagation axis (L1) (taken along a longitudinal dimension) of the first waveguide. A light propagation axis (L2) of the second waveguide is in examples parallel the light propagation axis of the first waveguide. In such examples, the substrate has a planar surface, with the first portion and the second portion of the substrate, and of the planar surface, in the same two dimensional plane as each other.

Such first and second distances can facilitate integration of the electro-optical modulator into generic PIC platforms where it is required for all of the electrodes to be the same distance from the substrate as this allows simpler, cheaper and quicker fabrication of the PIC.

A surface of the first waveguide in contact with the first electrode is substantially coplanar with a surface of the second waveguide in contact with the second electrode, as illustrated for example by FIGS. 1 to 3. A person skilled in the art will appreciate that two surfaces are substantially coplanar when both surfaces lie (within acceptable manufacturing and/or performance tolerances) in the same two-dimensional plane (P1). Such coplanarity e.g. reduces the capacitance between the electrodes, to give faster modulation of the electrical potential difference between the first electrode and the second electrode. In some examples this allows 100 GHz operation and 150 Gbps non-return-to-zero (NRZ) operation; however, depending on the chosen dimensions and materials of elements of the modulator, e.g. the waveguides and electrodes, greater or lesser performance is envisaged.

In the examples such as those illustrated by FIGS. 1 to 3 a width (D7) of the first electrode is greater than a width (D8) of the first waveguide. Similarly, a width of the second electrode is greater than a width of the second waveguide. Each of the widths is perpendicular the light propagation axis (L1) of the first waveguide. In some examples, a portion of at least one of the first electrode and/or a portion of the second electrode each extend beyond an outer surface of the first waveguide and the second waveguide respectively. In this way the portions of the electrodes can each be considered to be free- or over-hanging without the respective one of the first waveguide or the second waveguide beneath. This means that where certain dimensions and/or a volume of the first electrode and the second electrode are desired for a particular modulator performance, dimensions of the first and second waveguides for the desired modulator performance can be chosen more independently of the electrode dimensions. E.g., the electrodes can be positioned closer to or further away from each other without affecting a desired distance (D5) between the first waveguide and the second waveguide.

For example, as illustrated by FIGS. 1 to 3, a longitudinal surface (S1) of the first waveguide (closest to the second waveguide) is spaced from a surface (S2) of the second waveguide (closest to the first waveguide) and is substantially coplanar (within acceptable manufacturing and/or performance tolerances) with a surface (S3) of the first electrode (closest to the second electrode). The surface of the second waveguide closest to the first waveguide is coplanar with a surface of the second electrode closest to the first electrode. In this way, a spacing between the waveguides and a distance between the electrodes is the same, which can facilitate manufacture (e.g. one channel can be etched to form the inner surfaces of the electrodes and of the waveguides), but which can also simplify obtaining such inter-electrode and inter-waveguide spacings for a desired performance of the modulator.

In examples, such as those of FIGS. 1 to 3, by positioning the electrodes on the waveguides, and with the waveguides having a sufficiently narrow width, a desired capacitance and inductance of the line can be obtained. Consequently, such examples give reduced microwave loss and achieve velocity matching to the optical signal with a desirable impedance match without capacitive loading. In other electro-optical modulators and methods of optical modulation, the bandwidth is constrained by high electrical loss due to the electrode designs, and the line impedance is limited to 30 Ohms (Ω) at high frequencies which leads to undesired electrical reflections.

The distance between the first waveguide and the second waveguide is between 1 micrometres (μm) and 50 μm, for example. In some examples, at least one of the first waveguide or the second waveguide is between 0.5 millimetres (mm) and 5 mm in length along the respective light propagation axis. At least one of the first waveguide or the second waveguide is e.g. between 0.5 μm and 5 μm in width perpendicular to the light propagation axis. Such dimensions contribute e.g. to particular path length modulation, capacitance and/or footprint characteristics desired for the electro-optical modulator.

The substrate is for example a compound of elements from groups III and V of the Periodic Table, for example a so-called III-V semiconductor compound such as Indium Phosphide (InP).

In examples, the first waveguide and the second waveguide each have the same construction, and so are formed of the same materials. E.g., each of the waveguides comprise, e.g. is formed of, InP. Using such a semiconductor material with a strong electro-optical effect, low electrical loss and a low optical loss can be achieved for a generic platform.

As a person skilled in the art appreciates, each electrode comprises, e.g. is formed of, a sufficiently high electrically conductive material such as Gold (Au). Other electrical conductors are envisaged in other examples, such as: Silver (Ag), Platinum (Pt), Nickel (Ni), Carbon (C), Cadmium (Cd), Tungsten (W), Aluminium (Al), or Copper (Cu).

Between the first waveguide and the second waveguide, there is for example at least one of a fluid, a gas or air. This separation of the first waveguide and the second waveguide helps to reduce optical interference between the first waveguide and the second waveguide and to reduce electrical crosstalk between the first waveguide and the second waveguide.

Similarly, between the first and second electrodes, there is for example at least one of a fluid, a gas or air, which may be the same fluid, gas or air as between the waveguides, and again may be the only material between the electrodes. The choice of material between the electrodes will affect the capacitance and impedance between the electrodes and allow tuning of these properties for the modulator.

Further examples will now be described with reference to FIGS. 4 to 13.

FIG. 4 illustrates examples of parts of an electro-optical modulator (200) for a PIC. Features of these examples are similar to features described above, and will be referred to using the same reference numeral incremented by 200 instead of 100; corresponding descriptions for such features apply here also.

The first waveguide (230) comprises a portion of n-type semiconductor (206) in contact with the substrate; a portion of intrinsic semiconductor (208) on the portion of n-type semiconductor; a portion of a first p-type semiconductor (210) on the portion of intrinsic semiconductor; and a portion of a second p-type semiconductor (212) on the portion of the first p-type semiconductor and in contact with the first electrode (214). The second waveguide (240) comprises a second portion of n-type semiconductor (216) in contact with the substrate; a second portion of intrinsic semiconductor (218) on the second portion of n-type semiconductor; a second portion of a first p-type semiconductor (220) on the second portion of intrinsic semiconductor; and a second portion of a second p-type semiconductor (222) on the second portion of the first p-type semiconductor and in contact with the second electrode (224). This structure of the first waveguide and the second waveguide each provide a vertical n-i-p-p semiconductor structure, which in some examples reduces the size of the electro-optical modulator and provides waveguides suitable for fast electro-optical modulation.

The substrate in examples such as of FIG. 4 comprises: a semi-insulator (202); and a surface of an n-type semiconductor (204) on a surface of a semi-insulator. The surface of an n-type semiconductor (204) leads to simplification of integration of the electro-optical modulator (200) into a PIC.

FIG. 5 illustrates further examples of parts of an electro-optical modulator (300) for a PIC. Features of these examples are similar to features described above, and will be referred to using the same reference numeral incremented by 300 instead of 100 or 200; corresponding descriptions for such features apply here also. The first waveguide (330) comprises: a portion of a first n-type semiconductor (306) in contact with the substrate (350); a portion of intrinsic semiconductor (308) on the portion of first n-type semiconductor; a portion of the first n-type semiconductor or of a second n-type semiconductor (310) on the portion of intrinsic semiconductor; and a portion of p-type semiconductor (312) on the a portion of the first n-type semiconductor or of a second n-type semiconductor and in contact with the first electrode (314). The second waveguide (340) comprises: a second portion of the first n-type semiconductor (316) in contact with the substrate (350); a second portion of intrinsic semiconductor (318) on the second portion of the first n-type semiconductor; a further portion of the first n-type semiconductor or of a second n-type semiconductor (320) on the second portion of intrinsic semiconductor; and a second portion of p-type semiconductor (322) on the further portion of the first n-type semiconductor or of a second n-type semiconductor and in contact with second first electrode (324). This structure of the first waveguide and the second waveguide each provide a vertical (as illustrated) n-i-n-p semiconductor structure, which in some examples is for reducing the size of the electro-optical modulator and for providing waveguides suitable for fast electro-optical modulation.

FIG. 6 illustrates other examples of parts of an electro-optical modulator (400) for a PIC. Features of these examples are similar to features described above, and will be referred to using the same reference numeral incremented by 400 instead of 100, 200 or 300; corresponding descriptions for such features apply here also. The first waveguide (430) comprises: a portion of n-type semiconductor (406) in contact with the substrate (450); and a portion of a p-type semiconductor (410) on the portion of n-type semiconductor and in contact with the first electrode (414). The second waveguide (440) comprises: a second portion of n-type semiconductor (416) in contact with the substrate (450); and a second portion of a p-type semiconductor (420) on the second portion of n-type semiconductor and in contact with the second electrode (424). This structure of the first waveguide and the second waveguide each provide a vertical (as illustrated) n-p semiconductor structure, which in some examples reduces the complexity and cost of manufacture of the structure.

FIG. 7 illustrates examples of parts of an electro-optical modulator (500) for a PIC. Features of these examples are similar to features described above, and will be referred to using the same reference numeral incremented by 500 instead of 100, 200, 300 or 400; corresponding descriptions for such features apply here also. FIG. 7 illustrates an example electro-optical modulator (500) for a PIC comprising a solid dielectric material (570) between the first electrode (514) and the second electrode (524), and a solid electrical insulator (560) between the first waveguide (530) and the second waveguide (540). The dielectric material will affect the capacitance and impedance between the first electrode and the second electrode, and the electrical insulator will affect the optical interference between the first waveguide and the second waveguide. Each of the dielectric material and the electrical insulator therefore allow the tuning of these properties for performance of the modulator. The dielectric material is for example a poly-imide; however, other dielectric materials are envisaged. The electrical insulator is for example a solid cured polymer; however, in other examples, other solid materials may be arranged between the first waveguide (530) and the second waveguide (540), such as other solid dielectric materials.

FIG. 8 illustrates schematically, in accordance with examples, applying a potential difference (680) between the substrate and at least one of the first electrode or the second electrode which allows at least one of the first waveguide or the second waveguide to be biased. FIG. 8 also illustrates applying a first potential difference or a second potential difference (depending on the magnitude in volts) (690) between the first electrode and the second electrode. Modulating the potential difference between first electrode and the second electrode modulates, or changes, the difference between the potential difference across the first waveguide and the potential difference across the second waveguide, and therefore the difference in effective optical path length between the first waveguide and the second waveguide due to the electro-optical effect. Examples are configured in a push-pull method of modulation; however, other methods of modulation such as single drive are envisaged. As will be appreciated, features of these examples are similar to features described above, and will be referred to using the same reference numeral incremented by 600; corresponding descriptions for such features apply here also.

FIG. 9 illustrates schematically, in accordance with examples, a photonic integrated circuit (770) comprising the electro-optical modulator (700) of examples described herein. Embedding the electro-optical modulator into a generic photonic platform such as a PIC allows combination of the electro-optical modulator with other components. The PIC can be considered a monolithic PIC, with a single monolithic substrate and multiple optical components thereon. A person skilled in the art will appreciate that a PIC is often formed from a III-V semiconductor platform. Such a PIC can be fully contained without optical input or output and is sufficiently compact that it can be integrated in devices such as computers and smart phones. A semiconductor platform for use in a PIC comprises materials and is manufactured according to the intended application of the PIC. Some examples of PICs comprise a waveguide structure to allow light to propagate from one part of the PIC to another in a desired manner. Some examples of PICs comprise electrical circuitry which allow external control of components of the PIC by appropriate electrical connections to electrodes or other electrical contacts on the PIC. In examples herein, and as explained further below, the first electrode (714) and the second electrode (724) are for electrical connection to electrical circuitry for controlling the modulation. As will be appreciated, features of these examples are similar to features described above, and will be referred to using the same reference numeral incremented by 700; corresponding descriptions for such features apply here also.

FIG. 10 illustrates examples of a PIC (870) comprising the electro-optical modulator (800) of examples described herein; an optical source (880); an optical splitter (810) for splitting light from the optical source and directing the light after splitting to the first waveguide beneath the first electrode (814) and the second waveguide beneath the second electrode (824); and an optical combiner (830) for combining light from the first waveguide and the second waveguide. The wavelength of the optical source is e.g. between 10 nanometres and 1 mm. In some examples, the optical source is a semiconductor laser which e.g. allows integration of the light source onto the same substrate as the electro-optical modulator. Other optical sources are envisaged as alternatives, such as: a diode, a solid-state laser, a gas laser or a lamp. The optical splitter and optical combiner e.g. comprise a 2×1 multimode interferometer; however other optical combiners and optical splitters are envisaged for further examples, such as: other multimode interferometers, beam splitters, an optical fibre coupler or an optical fibre splitter. Features of these examples are similar to features described above, and will be referred to using the same reference numeral incremented by 800; corresponding descriptions for such features apply here also.

In examples, a connection between the optical source and the optical splitter, connections between the optical splitter and the first waveguide and the second waveguide, and a connection between the optical combiner and the first waveguide and the second waveguide, are achieved in different ways in different examples. In some examples these connections are achieved with waveguides; however, in other examples, other connections are envisaged, such as free-space propagation, and optical fibre connections. In some examples a tapered waveguide connects: the optical source and the optical splitter, the optical splitter and the first waveguide and the second waveguide, or the optical combiner and the first waveguide and the second waveguide.

Some examples comprise electrical insulator between the first electrode and the optical source. This allows reduced electrical interference between the first electrode and the optical source. An electrical insulator portion e.g. has a sufficiently low electrical conductivity to sufficiently reduce cross-talk between the electrode and the source.

FIG. 11 schematically illustrates examples of a system for electro-optical modulation comprising: the PIC as previously described (970); and a controller (992) configured to: apply the potential difference between the substrate and at least one of the first electrode or the second electrode, and to switch between applying the first potential difference and applying the second potential difference between the first electrode and the second electrode. A controller may be or comprise an electrical source or driver, to apply a direct current (DC) and/or alternating current (AC) potential difference. The PIC comprises the parts of the electro-optical modulator (900) and electrical connections (990) connected to the first and second electrodes and the controller. In some examples the difference in volts between the first potential difference and the second potential difference is such that light propagating through the first waveguide is shifted in phase from light propagating through the second waveguide by 180°. Features of these examples are similar to features described above, and will be referred to using the same reference numeral incremented by 900; corresponding descriptions for such features apply here also.

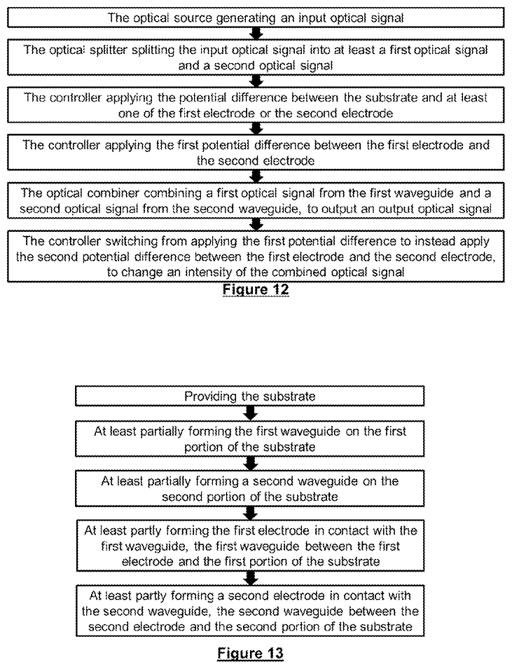

FIG. 12 schematically illustrates a method of modulating an optical signal in accordance with examples: the optical source generating an input optical signal; the optical splitter splitting the input optical signal into at least a first optical signal and a second optical signal; the controller applying the potential difference between the substrate and at least one of the first electrode or the second electrode; the controller applying the first potential difference between the first electrode and the second electrode; the optical combiner combining a first optical signal from the first waveguide and a second optical signal from the second waveguide, to output an output optical signal; and the controller switching from applying the first potential difference to instead apply the second potential difference between the first electrode and the second electrode, to change an intensity of the combined optical signal.

FIG. 13 schematically illustrates a method of manufacturing an electro-optical modulator in accordance with examples, comprising: providing the substrate; at least partly forming the first waveguide on the first portion of the substrate; at least partly forming the second waveguide on the second portion of the substrate; at least partly forming the first electrode in contact with the first waveguide, the first waveguide between the first electrode and the first portion of the substrate; and at least partly forming a second electrode in contact with the second waveguide, the second waveguide between the second electrode and the second portion of the substrate. Examples of techniques for at least partially forming a substrate, a waveguide, a portion of semiconductor or an electrode are: metalorganic vapour-phase epitaxy, surface passivation, photolithography, ion implantation, etching, dry etching ion etching, wet etching, buffered oxide etching, plasma ashing, thermal treatment, annealing, thermal oxidation, chemical vapor deposition, atomic layer deposition, physical vapor deposition, molecular beam epitaxy, laser lift-off, electrochemical deposition, electroplating, or chemical-mechanical polishing. In some examples etching techniques are used to remove portions of material, as part of patterning, as the skilled person will appreciate. In some examples the substrate is a monolith for a PIC comprising the electro-optical modulator, which allows integration of the electro-optical modulator into more complex circuits.

The above examples are to be understood as illustrative examples of the invention. Further examples of the invention are envisaged. For example, the semiconductors, semi-insulators and insulators described herein may be at least one of Indium Phosphide (InP), Gallium Arsenide (GaAs), Gallium Antimonide (GaSb), Gallium Nitride (GaN), Indium Gallium Arsenide (InGaAs), Indium Aluminium Arsenide (InAlAs), Aluminium GallliumIndium Aluminium Gallium Arsenide (InAlGaAs), Indium Gallium Arsenide Phosphide (InGaAsP), Silicon (Si), Silicon Nitride (Si₃N₄), or Silicon Oxide (SiO₂); however, other semiconductor, semi-insulator and insulator materials are envisaged.

It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the accompanying claims.

What is claimed is:

1. An electro-optical modulator for a photonic integrated circuit, comprising:
a substrate;
a first waveguide on a first portion of the substrate;
a second waveguide on a second portion of the substrate;
a first electrode in contact with the first waveguide, the first waveguide between the first electrode and the first portion of the substrate; and
a second electrode in contact with the second waveguide, the second waveguide between the second electrode and the second portion of the substrate.

2. The electro-optical modulator of claim 1, wherein a first distance between the first electrode and the first portion of the substrate is substantially the same as a second distance between the second electrode and the second portion of the substrate, the first distance and the second distance each perpendicular a light propagation axis of the first waveguide.

3. The electro-optical modulator of claim 1, wherein a surface of the first waveguide in contact with the first electrode is substantially coplanar with a surface of the second waveguide in contact with the second electrode.

4. The electro-optical modulator of claim 1, comprising at least one of: an electrical insulator, a fluid, a gas or air between the first waveguide and the second waveguide.

5. The electro-optical modulator of claim 1, wherein at least one of the first waveguide or the second waveguide each comprises at least one of:
I) a portion of n-type semiconductor in contact with the substrate,
a portion of intrinsic semiconductor on the portion of n-type semiconductor,
a portion of a first p-type semiconductor on the portion of intrinsic semiconductor, and
a portion of a second p-type semiconductor on the portion of the first p-type semiconductor and in contact with the first electrode;
II) a portion of a first n-type semiconductor in contact with the substrate,
a portion of intrinsic semiconductor on the portion of first n-type semiconductor,
a portion of the first n-type semiconductor or of a second n-type semiconductor on the portion of intrinsic semiconductor, and
a portion of p-type semiconductor on the portion of the first n-type semiconductor or of a second n-type semiconductor and in contact with the first electrode;
or
III) a portion of n-type semiconductor in contact with the substrate, and
a portion of a p-type semiconductor on the portion of n-type semiconductor and in contact with the first electrode.

6. The electro-optical modulator of claim 1, the substrate comprising:
a semi-insulator layer; and
an n-type semiconductor layer on the semi-insulator layer.

7. The electro-optical modulator of claim 1, wherein the first waveguide is spaced from the second waveguide by between 1 μm and 50 μm.

8. The electro-optical modulator of claim 1, wherein a length of at least one of the first waveguide and the second waveguide is between 0.5 mm and 5 mm along the light propagation axis of the first waveguide or the second waveguide respectively.

9. The electro-optical modulator of claim 1, wherein the first waveguide is between 0.5 μm and 5 μm in width taken perpendicular the light propagation axis and perpendicular to a distance between the first electrode and the first portion of the substrate.

10. The electro-optical modulator of claim 1, wherein at least one of:
the first waveguide comprises InP;
the second waveguide comprises InP;
the first electrode comprises gold; or
the second electrode comprises gold.

11. The electro-optical modulator of claim 1, comprising a dielectric material between the first electrode and the second electrode.

12. A photonic integrated circuit comprising:
an electro-optical modulator, comprising:
a substrate;
a first waveguide on a first portion of the substrate;
a second waveguide on a second portion of the substrate;
a first electrode in contact with the first waveguide, the first waveguide between the first electrode and the first portion of the substrate; and
a second electrode in contact with the second waveguide, the second waveguide between the second electrode and the second portion of the substrate; and
electrical circuitry for controlling the electro-optical modulator.

13. The photonic integrated circuit of claim 12, the electrical circuitry configured to at least one of:
apply a potential difference between the substrate and at least one of the first electrode or the second electrode; or
apply a first potential difference or a second potential difference between the first electrode and the second electrode.

14. The photonic integrated circuit of claim 12, comprising:
at least one of an optical source or a semiconductor laser;
an optical splitter for splitting light from the optical source or the semiconductor laser and directing the light after splitting to the first waveguide and the second waveguide; and
an optical combiner for combining light from the first waveguide and the second waveguide.

15. The photonic integrated circuit of claim 14, comprising electrical insulator between the first electrode and the at least one of the optical source or the semiconductor laser.

16. The photonic integrated circuit of claim 13, the electrical circuitry connected to a controller configured to:
apply the potential difference between the substrate and at least one of the first electrode or the second electrode, and
switch between applying the first potential difference and applying the second potential difference between the first electrode and the second electrode.

17. The photonic integrated circuit of claim 16, wherein a difference in volts between the first potential difference and the second potential difference is such that light propagating through the first waveguide is shifted in phase from light propagating through the second waveguide by 180 degrees.

18. A method of modulating an optical signal using a photonic integrated circuit, the photonic integrated circuit comprising:
i) an electro-optical modulator comprising:
a substrate;
a first waveguide on a first portion of the substrate;
a second waveguide on a second portion of the substrate;
a first electrode in contact with the first waveguide, the first waveguide between the first electrode and the first portion of the substrate; and
a second electrode in contact with the second waveguide, the second waveguide between the second electrode and the second portion of the substrate, and
ii) an optical source;
iii) an optical splitter for splitting light from the optical source and directing the light after splitting to the first waveguide and the second waveguide; and
iv) an optical combiner for combining light from the first waveguide and the second waveguide; and
v) electrical circuitry connected to a controller configured to:
apply a potential difference between the substrate and at least one of the first electrode or the second electrode, and
switch between applying a first potential difference and applying a second potential difference between the first electrode and the second electrode,
the method comprising:
the optical source generating an input optical signal;
the optical splitter splitting the input optical signal into at least a first optical signal and a second optical signal;
the controller applying the potential difference between the substrate and at least one of the first electrode or the second electrode;
the controller applying the first potential difference between the first electrode and the second electrode;
the optical combiner combining a first optical signal from the first waveguide and a second optical signal from the second waveguide, to output an output optical signal; and
the controller switching from applying the first potential difference to instead apply the second potential difference between the first electrode and the second electrode, to change an intensity of the output optical signal.

19. A method of manufacturing the electro-optical modulator the method comprising:
providing a substrate;
at least partly forming a first waveguide on a first portion of the substrate;
at least partly forming a second waveguide on a second portion of the substrate;
at least partly forming a first electrode in contact with the first waveguide, the first waveguide between the first electrode and the first portion of the substrate; and
at least partly forming a second electrode in contact with the second waveguide, the second waveguide between the second electrode and the second portion of the substrate.

20. The method of claim 19, wherein the substrate is a monolith for a photonic integrated circuit.
